(19) United States
(12) Patent Application Publication
(10) Pub. No.: US 2006/0269213 A1
(43) Pub. Date: Nov. 30, 2006

(54) Illumination apparatus providing longitudinal illumination

(75) Inventors: Gwo-Feng Hwang, Taipei City (TW); Shih-Yen Lee, Jhonghe City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Bright View Electronics Co., Ltd.

(21) Appl. No.: 11/195,810

(22) Filed: Aug. 3, 2005

(30) Foreign Application Priority Data
May 31, 2005 (TW) 094117836

(51) Int. Cl. G02B 6/10

(52) U.S. Cl. 385/146

(57) ABSTRACT

An illumination device using an innovative design to provide a uniform, highly concentrated and substantially longitudinal illumination. The device includes, at least one light source unit, a compound light guide with a built-in light-extracting feature and a reflective envelope. The compound light guide comprises two optically coupled sub-guides. A first sub-guide has a constant cross-section area with a profile optimized for an integral light-concentrating optics, and a second sub-guide has a varying cross-section area for controlling local light flux density inside the light guide and providing assembly means. Said light extracting feature having variable light extraction efficiency improves illumination uniformity at an area close to a light input end of the light guide without displacing a light source from the central normal line of a light-extracting feature. The extracted light from the light-extracting feature forms an effective light-emitting object with a constant width for the integral light-concentrating optics and therefore, the width of the light-extracting feature can be modulated to improve illumination uniformity without affecting the width of illumination. The reflective envelope recycles all light leaked out of the light guide and protects the light guide from environmental contamination and provides mechanical interface between the device and the application assembly.

### FIELD OF THE INVENTION

The present invention relates generally to a low-profile illuminating device employing a light guide to provide a longitudinal, uniform and highly concentrated illumination.

### BACKGROUND OF THE INVENTION

Document processing devices such as scanners, fax-machines and electronic copy machines need a uniform, efficient and sufficiently intense longitudinal illumination on a target document. As a consequence of the requirement for both efficiency and intensity, a longitudinal illumination is preferred. The required illumination can be provided by a discharge tube such as a fluorescent lamp or a light-emitting-diode (LED) array consisting of a plurality of LEDs. Recently, with the advance in the LED technology and the sensor technology, the required illumination flux can be supplied by a couple of LEDs. Therefore, there is a need for an illumination device which can provide a longitudinal illumination for document processing devices by using a limited number of LEDs.

It has been well known that a light guide such as optical fiber can guide light from a single light source to a desired location remote from the light source without encountering substantial transmission losses. Furthermore, a light guide with properly built-in light directing features along its length can be used to provide a longitudinal illumination. Illumination systems based on a light guide are formed by modifying the light guide to redirect an incremental amount of the total amount of light propagating through the guide laterally.

In general, two factors determine the distribution of illumination intensity of a device based on a light guide. The first factor is the local light flux density inside the light guide and the second factor is the local light-extracting efficiency. The amount of output light and consequently the intensity of illumination is proportional to the product of these two factors. Although a certain amount of output light is necessary for providing a certain intensity of illumination, a light-concentrating optics is further desirable to project substantially all of the all output light into a defined zone of a target plane in order to achieve a high energy efficiency and to reduce harmful scattered light.

A conventional method of increasing or reducing the local light flux density inside a light guide is to increase or reduce the local cross-section area of the light guide. However, varying the cross-section of a light guide usually eliminates or limits the possibility of integrating a light-concentrating optics into the light guide. In addition, an achievable modulation of local light flux density is limited because of possible violation of total internal reflection conditions.

In principle, the local light-extracting efficiency of a light guide can be modulated by varying the projected area of a light-extracting feature, for example, varying the width of a scattering pattern. However, width variation of a light-extracting feature as described in the prior art results in a proportional width variation of the illumination zone, which means no increase in illumination intensity despite an increase in output light flux. Varying the gap between individual light-extracting features can be used to modulate output light amount as well, but this method may result in an unacceptable high frequency intensity modulation in an illumination plane.

There are numerous methods by which a longitudinal light guide can be prepared to effect a lateral transmission of light. For example, the light guide can be cut with grooves at various points along its length, with one or more of the groove surfaces coated with a reflective material. Examples of illuminators prepared by the discussed techniques are generally disclosed in U.S. Pat. No. 4,052,120 issued to Sick et al.; U.S. Pat. No. 4,172,631 issued to Yevick; U.S. Pat. No. 4,173,390 issued to Kach; and U.S. Pat. No. 4,196,962 issued to Sick. Alternatively, grooves with profiles other than triangles and without using a reflective material can be used in a light guide as disclosed in U.S. Pat. No. 5,835,661 issued to Tai et al.

While illuminators prepared using techniques disclosed in the above-mentioned patents may provide some lateral light emission along a light guide, the illumination is generally divergent and a further control of illumination uniformity as required by document reading devices is not possible. Some prior art designs have tried to provide a means to concentrate illumination. See, for example, U.S. Pat. No. 2,825,260 to O'Brien which shows a triangular light guide, amongst other shapes; U.S. Pat. No. 4,678,279 to Mori which shows a modified cylindrical light conducting member; and U.S. Pat No. 5,295,047 to Windross and U.S. Pat. No. 6,206,534 to Jenkins et al. which use an integral optical lens together with a light guide pipe having an isosceles triangular cross-section. Nevertheless, the light guides shown in these prior patents are generally not capable of being used to illuminate a longitudinal area with a sufficiently uniform intensity.

To achieve good illumination uniformity, U.S. Pat. No. 5,808,295 issued to Takeda et al. and U.S. Pat. No. 5,905,583 issued to Kawai et al. use a light guide with variable cross-section and place a light source deviated sideward from the normal line passing through a center of the reflection area of the light guide. While the designs according to these prior patents improve the illumination uniformity, using variable cross-section also limit the possibility of using a light concentration feature to control the width and position of an illumination zone or achieve a highly concentrated illumination. Furthermore, placing a light source deviated sideward from the normal line of the reflection area constrains the freedom of LED packaging and assembly of LED to a light guide. The U.S. Pat. No. 6,464,366 issued to Lin et al. discloses a light-homogenizing section to achieve desired uniformity near the light source without need to place a light source deviated sideward from the normal line of the reflection area. However, this light homogenizing section unavoidably adds the light guide length, which is not acceptable for some applications with very limited space.

To maintain the possibility of using a light concentration optics to achieve a highly concentrated illumination and the possibility of using a light guide with variable cross-section to achieve a uniform illumination, U.S. Pat. No. 6,464,366 issued to Lin et al. employs a light guide comprising two optically coupled sub-guides. The first sub-guide has a predetermined cross-sectional shape and a substantially uniform cross-sectional area along the longitudinal length of the light guide. The second sub-guide also has a predetermined cross-sectional shape but has a varying cross-sectional area along the longitudinal length of the light guide that controls light flux density within the light guide. Since the function of controlling local light intensity and the function of focusing light are performed by different sub-guides, an illuminating device constructed in accordance with the U.S. Pat. No. 6,464,366 does provide a highly uniform illumination output with a high grade of light concentration. In such a design light propagation inside the light guide solely relies on total internal reflection, which is a loss-free process if the guide surface is perfectly smooth. However, a real light guide always has some defects on its surface. These imperfections can cause light leakage, degrading output light intensity. Although the U.S. Pat. No. 6,464,366 acknowledged and claimed the use of reflection means outside the light extracting feature to catch the leaked light, it did not teach how to implement such kind of reflection means.

There thus exists a long felt and unresolved need to provide an illumination device that overcomes the above-described short comings of the prior art.

### SUMMARY OF THE INVENTION

The present invention is directed to an illumination device that advantageously provides, in a novel and unobvious way, a substantially longitudinal, uniform, and concentrated light output. The illumination device is preferably constructed as a three-part assembly comprising at least one light source unit, a light guide with integrated light extraction feature and an optional light-concentrating optics, and a highly reflective envelope. The light extracting feature can be created during the guide molding process or later by printing. The extraction efficiency of the light-extracting feature varies along the length of the light guide so that a very uniform illumination can be achieved without use of a light-homogenizing section. In another embodiment, the light guide shape is constructed in such a way that light after entering the guide has little chance to be extracted out immediately and output illumination near the light entrance of the light guide is mainly due to the contribution from light rays which are reflected back after reaching the far end of the light guide. Therefore, the uniformity of output light near the light entrance becomes independent of the relative position of the light source unit and its intensity distribution.

Most part of the surface of the light guide is covered by a conformed envelope. Light escaping the light guide from places other than the designed output surface is reflected back to the light guide by the reflective envelope surface. Since the reflective envelope surface and the light guide surface are not optically coupled, loss-free total internal reflection inside the light guide is not affected by the presence of the reflective envelope. The reflective envelope only catches and recycles leaked light rays, hence the system efficiency is increased.

Another optional function of said reflective envelope is to provide a proper mechanical interface between a light guide and a device, in which the light guide is deployed. Since the reflective envelope does not require optical finish, it is more economic to modify the reflective envelope than to modify the light guide. Using the reflective envelope as an adaptive interface allows the light guide of the same design to be used in different devices without costly reengineering of the light guide. An illuminating device constructed in accordance with the present invention thus provides a highly uniform illumination output with a high grade of light concentration, facilitates easy assembly, allows more freedom in light source unit packaging, and may be reengineered at a relatively low cost.

In one embodiment of the present invention, a first section of the light guide with an integrated light-concentrating optics has a predetermined cross-sectional shape and a substantially uniform cross-sectional area along the longitudinal length of the light guide. This section has a defined entrance opening and a defined output surface. The entrance opening is located between the first section of the light guide and a second section. The entrance opening of the first section is optically connected to the second section with the light-extracting feature to redirect light striking thereon towards the entrance opening of the first section to form an effective light-emitting object for the light-concentrating optics. The second section of the light guide also has a predetermined cross-sectional shape but has a varying cross-sectional area along the longitudinal length of the light guide in the way that cross-sectional area is the minimum or maximum at the entrance of the light guide.

The invention accordingly comprises the features of construction, combination of elements, and arrangement of parts which will be exemplified in the disclosure hearin, and the scope of the invention will be indicated in the claims.

### BRIEF DESCRIPTION OF THE DRAWINGS

In the drawing figures, which are not to scale, and which are merely illustrative, and wherein like reference characters denote similar elements throughout the several views:

FIG. 1A is a perspective view of an illumination device constructed in accordance with an embodiment of the present invention;

FIG. 1B is a cross-sectional view taken along the line 1a-1a′ of FIG. 1A and depicts the assembly relationship between a reflective envelope and a light guide constructed in accordance with an embodiment of the present invention;

FIG. 2 is a cross-sectional view taken along the line 1b-1b′ of FIG. 1B, which depicts the optical relationship between the light extraction feature and the output surface with integrated light-concentrating optics in accordance with an embodiment of the present invention;

FIG. 3 is a perspective view of a light guide designed in accordance with an embodiment of the present invention;

FIG. 4 is a cross-sectional view of an illumination device constructed in accordance with another embodiment of the present invention;

FIG. 5 is a detailed side view of an illumination device constructed in accordance with yet another embodiment of the present invention;

FIGS. 6-8 are side views of embodiments of prismatic structures in accordance with the present invention.

### DETAILED DESCRIPTION OF THE PREFERRED EMBODIMENTS

The present invention is directed to an high efficient illumination device that advantageously provides, in a novel and unobvious way, a substantially longitudinal, uniform, and concentrated light output. The illumination device is preferably constructed as a three-part assembly comprising at least one light source unit, a light guide and a reflective envelope that receives the light guide. The light guide has first and second optically coupled sub-guides. A light-extracting feature is integrated into the second sub-guide and optically coupled to an entrance opening of the first sub-guide. The light-extracting feature redirects light within the light guide to form an effective light-emitting object at the entrance opening. Light from that effective light emitting object is projected out of the light guide by light-concentrating optics provided by the internal surfaces of the first sub-guide. The first sub-guide has a predetermined cross-sectional shape and a substantially uniform cross-sectional area along the longitudinal length of the light guide. The second sub-guide also has a predetermined cross-sectional shape, preferably a polygon shape, but may have a varying cross-sectional area along the longitudinal length of the light guide that controls light flux density within the light guide. The light-extracting feature has a variable light-extracting efficiency along the longitudinal length of the light guide, providing further control over the illumination uniformity. The reflective envelope has a generally concave cross-section to receive the light guide. The inside surface of the envelope is highly reflective so that any light ray that leaks out the light guide is redirected back into the light guide with minimum loss. The outside surface of the envelope may have proper fastening features that facilitate assembling of the illumination device to an application target.

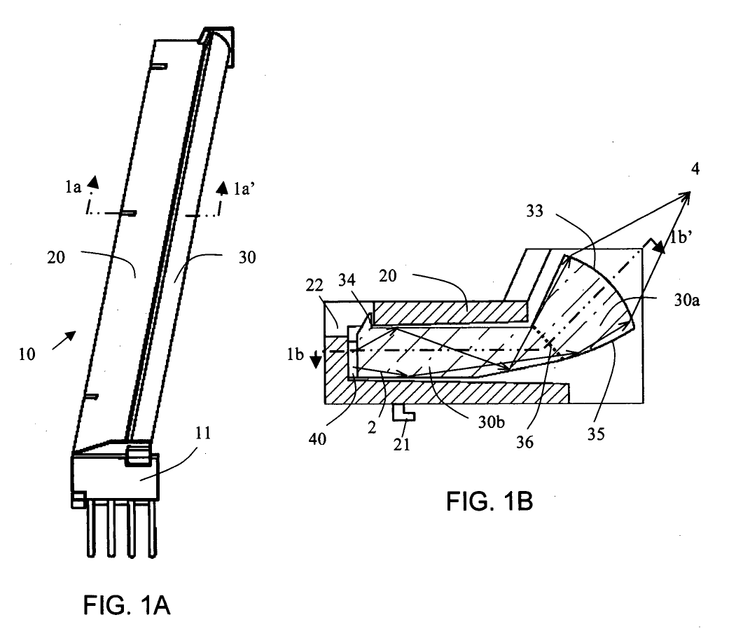

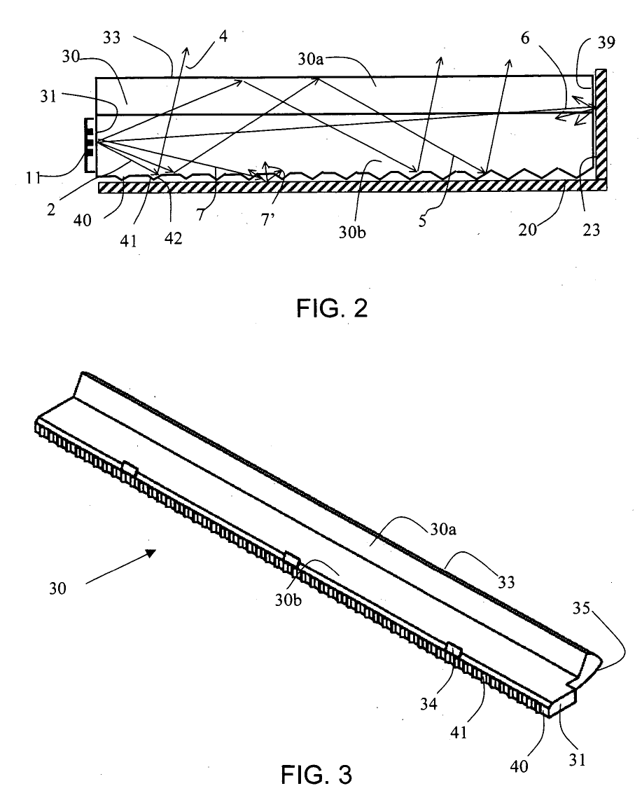

Referring to FIG. 1A of the drawings, there is illustrated a perspective view of an illumination device, generally designated 10, constructed in accordance with an embodiment of the present invention. In order to demonstrate the detailed structure of the assembly, FIG. 1B depicts a cross-sectional view of the illuminating device 10 taken along the line 1a-1a′ of FIG. 1A. FIG. 2 shows a cross-section view of the illumination device 10 taken along the line 1b-1b′ of FIG. 1B.

As shown in FIG. 1A, the illumination device 10 includes a light source unit 11, an reflective envelope 20 and a light guide 30.

As shown in FIG. 1B, a cross-section view of the illumination device 10, the reflective envelope 20 has a concave cross section to receive the light guide 30. The first sub-guide 30a projects light output from the illumination device 10 using integral light-concentrating optics 35 and the second sub-guide guide 30b controls local light flux density inside the light guide 30. The light guide 30 includes light-extracting feature 40 coupled to the second sub-guide 30b for redirecting light toward the output surface 33 of the light guide 30. The reflective envelope 20 covers the substantially entire surface of the light guide 30 except its output surface 33. This reflective envelope 20 has multiple functions including protecting the light guide 30 surface from contamination, recycling light leaked out of the light guide 30 and providing a proper assembly interface 21 between the light guide 30 and a device that deploys the illumination device 10. The light guide 30 can be reliably and conveniently assembled into the reflective envelope 20 by means of a fastening pin 34 fitting into a void 22 in the reflective envelope 20. For a reliable assembly, at least two pairs of fastening pin 34 and void 22 are required.

Referring to FIG. 2, the light guide 30 transmits light through its longitudinal length by internal reflection and has a light input end 31 through which light enters the light guide 30 from the light source unit 11. The light source unit 11 can comprise any suitable light sources including an LED, an LED array, an incandescent light source, a laser, or other similar light generating sources. The light source unit 11 may produce a single color of light, or multiple colors of light, as a matter of design choice. After a light ray enters the light guide 30 at its light input end 31, it may encounter the light-extracting feature 40, as indicated by a ray path 2, and is thereby redirected upwards and further projected by the integral light-concentrating optics 35 out of the illumination device 10 as output light 4. The ray path 2 is also depicted in another view in FIG. 1B. Alternatively, the light may propagate forward and encounter the light-extracting feature 40 later as indicated by a ray path 5 or along the entire length of the light guide 30 until reaching the another end 39 and being reflected back by a reflective surface of the reflective envelope 20, as indicated by a ray path 6. Most light rays propagating inside the light guide 30 fulfill the condition of total internal reflection, under which light rays are reflected or extracted without experiencing any loss. However, a small number of light rays may not always fulfill the condition of total internal reflection due to their small incident angles on the light guide 30 surface or manufacturing defects on the light guide 30 surface. These light rays may leak out the light guide 30 as indicated by a ray path 7. These leaked light rays would result in loss if they were not reused. According to this invention, these leaked light rays will be caught and redirected by the reflective envelope 20 into the light guide 30 as indicated by a group ray paths 7′.

With continued reference to FIG. 2, the light extracting feature 40 in this embodiment consists of an array of prismatic structure 41 with their depth varying along the length of the light guide 30. Since a light ray will not be directed towards output until it hits an oblique side 42 of a prismatic structure 41, a shallow prism near the light input end 31 means a small chance for a light ray to hit its oblique side 42 and to be extracted. In other word, shallow prisms correspond to a low extracting efficiency in this region. Because light flux intensity in the light guide 30 close to its light input end 31 is very high, a low light extracting efficiency in this region compensates this high local light flux intensity resulting in a smooth output illumination. Consequently, in an illumination device 10 in accordance with this invention a local output intensity spike near the light input end 31 is avoided without using a light-homogenizing section as described in U.S. Pat. No. 6,464,366 or placing a light source deviated sideward from the normal line of the reflection area as described in U.S. Pat. No. 5,905,583. Through a careful design, a satisfactory illumination uniformity along the entire length of the light guide 30 can be achieved by properly adjusting the cross-section size of the second sub-guide 30b and the extracting efficiency of light extracting feature 40, which is readily achievable with help of current powerful computer modeling programs.

FIG. 3 shows a perspective view of a light guide 30 in accordance with this invention. The important features described above are indicated in this view again.

If a light source unit 11 comprises multiple discrete light emitting components with different colors, such as LED, it is desirable to properly mix light rays emitted by different components before allowing them to be extracted for illumination. Otherwise, a non-uniform color will appear in the illumination area near the light input end 31. To minimize such color non-uniformity, either light rays have to be mixed properly before they enter the light guide 30 or a certain space between the light input end 31 and the first light extracting structure of the light-extracting feature 40 is needed for light rays to mix. In practice, each of these measures means additional idle length of an illumination device 10. For most applications, an idle length is not acceptable because of limited space in the package, especially for applications where illumination zone is relatively short.

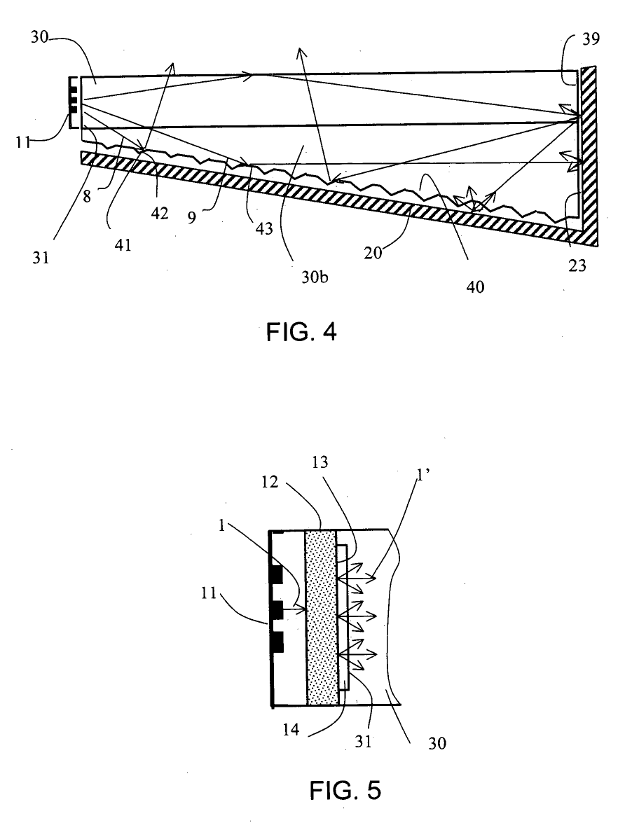

Another embodiment in accordance with this invention can solve this problem. This embodiment uses a second sub-guide 30b with its cross-section area gradually increasing with the distance from the light input end 31 as depicted in FIG. 4. Because such a second sub-guide 30b collimates light toward the far end 39 of the light guide 30, light after entering the light guide 30 is only little extracted along its first propagation path and most part is not extracted until after being reflected back by a reflective surface 23 of the reflective envelope 20 at the far end 39 of the light guide 30.

Referring to FIG. 4, after a light ray enters the light guide 30 at its light input end 31, it may have a chance to encounter an oblique side 42 in the array of the prismatic structure 41 and be further projected out of the light guide 30, as indicated by a ray path 8; however because of relatively shallow prisms, it may have a greater chance to encounter a flat 43 between prisms and thereby has its vector angle with respect to the elongated direction of the light guide 30 reduced as indicated by a ray path 9. Because of the reduction of its vector angle, this light ray 9 will have a further reduced chance to encounter the light extracting feature 40 again before reaching the far end 39 of the light guide 30. The same process happens to many light rays and consequently a significant amount of light can reach the far end 39 of the light guide 30 and be reflected by a diffusing reflective surface 23 of reflective envelope 20.

Because the reflective surface 23 is diffusing reflective, every light ray upon reflection will generate multiple secondary light rays with more or less similar angular distribution. Therefore, this reflective surface 23 can be considered as an effective light source with a very uniform intensity and angular distribution. After entering the light guide 30 again from its end 39, these light rays will experience similar processes as if they would enter the light guide 30 from its input end 31 in FIG. 2. However, in this case light rays come from a very uniform effective light source, a color non-uniformity or an illumination intensity spike near the far end 39 of the light guide 30 will not appear. Furthermore, a uniform illumination in terms of both color and intensity in the area near the light input end 31 can be achieved since the local light flux in this region subject to extraction is substantially from the contribution of the distant reflective surface 23. The embodiment as depicted in FIG. 4 is preferably used for applications where only a relative short light guide is needed and available space is limited.

In accordance to this invention, non-uniformity caused by discrete multiple light source unit 11 can be substantially eliminated by yet another embodiment as shown in FIG. 5. In this embodiment, a light-diffusing component 12 can be used between the light source unit 11 and the light input end 31. Light rays 1 emitted by a point-like LED light source unit 11 first enter a light-diffusing component 12 and exit the light-diffusing component 12 as an expanded light beam 1′, thereby effectively forming a secondary light source with a much larger emitting area than that of the individual light emitters in the light source unit 11. To ensure that conditions for total internal reflection are still fulfilled inside the light guide 30, an air-gap 14 is provided between the output surface 13 of the light-diffusing component 12 and the light input end 31 of the light guide 30. In practice, this kind of light-diffusing component 12 may be made as a cover plate of a light source unit 11, or it may be inserted as a separate plate into a gap between the light source unit 11 and the light input end 31 of the light guide 30. Alternatively, it can be made by injecting a curable light-diffusing resin into a gap located at the light input end 31 of the light guide 30.

If a light source unit 11 is provided at both ends of the light guide 30 (not shown), the cross-sectional area of a second sub-guide 30b preferably varies symmetrical with respect to the longitudinal mid-point of the light guide 30.

In accordance with the principle of the present invention, modulating the light-extracting efficiency may also be achieved by varying the width of the light-extracting feature 40 along the longitudinal length of the light guide 30. However, modulating light-extracting efficiency based on a width variation of a light-extracting feature 40 does not necessarily lead to an modulation in the illumination intensity, especially when the integral light-concentrating optics 35 are used. In the prior art designs, an increase in the width of a light-extracting feature 40 leads to a proportional increase in the width of an output illumination zone, but does not result in an increase in the output illumination intensity. For a document processing device, illumination intensity rather than total light flux is specified to characterize an illumination uniformity.

In accordance with the present invention, an illumination device 10 includes an effective light-emitting object having a constant width to solve the above-described problem. The integral light-concentrating optics 35 depicted in FIG. 1B are designed to work with this effective light-emitting object at the entrance opening 36 rather than directly to work with the original light-extracting features 40. Still referring to FIG. 1B, a light-extracting feature 40 is located inside the second sub-guide 30b. When a light ray 2 encounters the light-extracting feature 40, it is redirected generally upwards and into the first sub-guide 30a. Since the light-extracting feature 40 is located sufficiently deep inside the second sub-guide 30b, this light ray may experience one or more reflections on a side wall of the second sub-guide 30b before reaching an entrance opening 36 of the first sub-guide 30a. Such reflections may occur with many light rays redirected by the light-extracting feature 40. As a result, the entire entrance opening 36 may be filled up with extracted light rays regardless of the original width of the light-extracting feature 40 as long as the light-extracting feature 40 is spaced a sufficient distance from the entrance opening 36. Because of this property, the entrance opening 36 can be used as an effective light-emitting object for the integral light-concentrating optics 35 so a projected illumination zone will have a width that is correlated only with the width of the entrance opening 36 and independent of the actual width of the light-extracting feature 40. Therefore, by placing a light-extracting feature 40 a sufficient distance from the entrance opening 36 of a integral light-concentrating optics 35, the width of the light-extracting feature 40 may be varied to modulate illumination uniformity without affecting the width of the illumination zone.

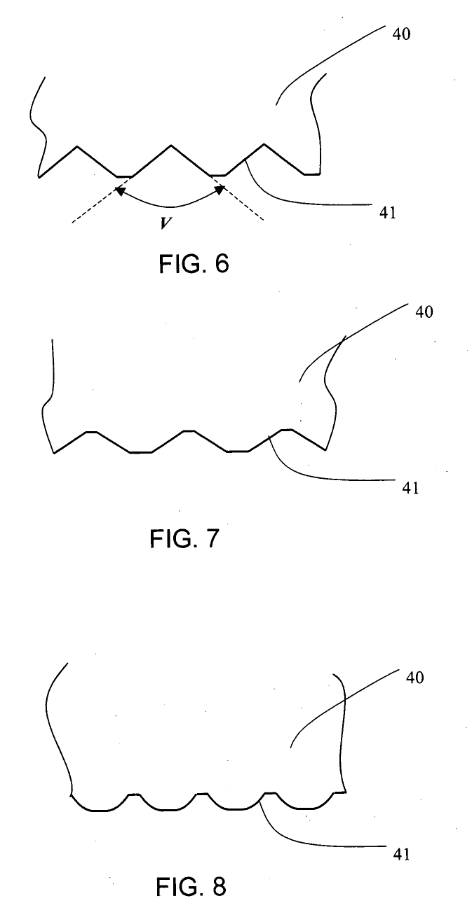

For each of light-extracting prismatic structures 41 having a generally triangular cross-sectional profile with substantially straight side surfaces, such as those depicted in FIG. 6, an opening angle V of between approximately 60° and 80°, or between approximately 95° and 120° is preferred. The choice of the opening angle V depends on the refractive index of the light guide 30 and acceptable illumination angular distribution.

Each of the prismatic structures 41 used as light-extracting features may have different cross-sectional profiles such as, by way of non-limiting example, a trapezoidal profile as depicted in FIG. 7, or a profile comprising at least one curved segment as depicted in FIG. 8. By using prismatic structures 41 with curved surfaces, the angular distribution of output light in the plane parallel to the light guide 30 length can be further modulated as needed and light leakage loss on prism surfaces can be further reduced.

Besides prismatic structures 41, other light reflecting or light scattering structure or patterns, which can be printed or embossed, may also be used as light-extracting feature 40 such as, for example, a white-paint strip with a varying width.

Although the light guide 30 disclosed herein is depicted in the drawing figures as substantially straight, a curved light guide 30 such as, for example, a generally circular, semi-circular, elliptical, oval, etc., is also contemplated by the present invention.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. An illumination device for producing an elongated light illumination, said illumination device comprising:
at least one light source unit;
a light guide comprising generally parallel and optically coupled first and second sub-guides, said first sub-guide having a generally constant cross-sectional area along the longitudinal length of said light guide and having an entrance opening extending longitudinally along said light guide, said second sub-guide having a varying cross-sectional area along the longitudinal length of said light guide with its maximum cross-section area near the end of said second sub-guide where light of the light source enters, said first sub-guide providing light-concentrating optics integral to said light guide and the operation of said light-concentrating optics being unaffected by said second sub-guide;
a light-extracting feature on a surface of said second sub-guide extending substantially longitudinally therealong, located in spaced apart relation to said entrance opening and having a varying light-extracting efficiency along the longitudinal length of said light guide; and
a reflective envelope being conformed to the part of the profile of said second sub-guide covering at least the surface where said light-extracting feature is located;
wherein when light from said light source enters said light guide at one or both ends of said light guide, said varying cross-sectional area of said second sub-guide controls a light flux density inside said light guide, a portion of light propagating inside said light guide being redirected by said light-extracting feature to form an effective light-emitting object at said entrance opening and further projected by said integral light-concentrating optics to provide a substantially longitudinal, uniform and concentrated light output while said reflective envelope catches and recycles leaked light back into said light guide.

2. An illumination device as recited by claim 1, wherein said light source unit comprises a plurality of light emitting diodes.

3. An illumination device as recited by claim 1, wherein said light-extracting feature comprises an array of prismatic structures of equal width and variable depth along the longitudinal length of said light guide.

4. An illumination device as recited by claim 1, wherein said light-extracting feature comprises an array of prismatic structures of equal depth and variable width along the longitudinal length of said light guide.

5. An illumination device as recited by claim 3 and 4, wherein each of said prismatic structures has a generally triangular cross-section.

6. An illumination device as recited by claim 3 and 4, wherein each of said prismatic structures has a generally trapezoidal cross-section.

7. An illumination device as recited by claim 5 or 6, wherein said cross-section of each of said prismatic structures comprises at least one curved segment.

8. An illumination device as recited by claim 1, wherein said light-extracting feature comprises printed light-scattering patterns.

9. An illumination device as recited by claim 1, wherein said light-extracting feature comprises embossed light-scattering patterns.

10. An illumination device for producing an elongated light illumination, said illumination device comprising:
at least one light source unit;
a light guide comprising generally parallel and optically coupled first and second sub-guides, said first sub-guide having a generally constant cross-sectional area along the longitudinal length of said light guide and having an entrance opening extending longitudinally along said light guide, said second sub-guide having a varying cross-sectional area along the longitudinal length of said light guide with its minimum cross-section area near the end of said second sub-guide where light of the light source enters, said first sub-guide providing light-concentrating optics integral to said light guide and the operation of said light-concentrating optics being unaffected by said second sub-guide;
a light-extracting feature on a surface of said second sub-guide extending substantially longitudinally therealong, located in spaced apart relation to said entrance opening and having a varying light-extracting efficiency along the longitudinal length of said light guide; and
a reflective envelope being conformed to the part of the profile of said second sub-guide covering at least the surface where said light-extracting feature is located;
wherein when light from said light source enters said light guide at one or both ends of said light guide, said varying cross-sectional area of said second sub-guide controls a light flux density inside said light guide, a portion of light propagating inside said light guide being redirected by said light-extracting feature to form an effective light-emitting object at said entrance opening and further projected by said integral light-concentrating optics to provide a substantially longitudinal, uniform and concentrated light output while said reflective envelope catches and recycles leaked light back into said light guide.

11. An illumination device as recited by claim 10, wherein said light source unit comprises a plurality of light emitting diodes.

12. An illumination device as recited by claim 10, wherein said light-extracting feature comprises an array of prismatic structures of equal width and variable depth along the longitudinal length of said light guide.

13. An illumination device as recited by claim 10, wherein said light-extracting feature comprises an array of prismatic structures of equal depth and variable width along the longitudinal length of said light guide.

14. An illumination device as recited by claim 12 and 13, wherein each of said prismatic structures has a generally triangular cross-section.

15. An illumination device as recited by claim 12 and 13, wherein each of said prismatic structures has a generally trapezoidal cross-section.

16. An illumination device as recited by claim 14 or 15, wherein said cross-section of each of said prismatic structures comprises at least one curved segment.

17. An illumination device as recited by claim 10, wherein said light-extracting feature comprises printed light-scattering patterns.

18. An illumination device as recited by claim 10, wherein said light-extracting feature comprises embossed light-scattering patterns.

19. An illumination device as recited by claim 1 and 10, wherein said reflective envelope having interface features to facilitate assembly of said illumination device.

20. An illumination device as recited by claim 1 and 10 further comprises a light-diffusing component between said light source unit and said light guide.
